(19) United States
(12) Patent Application Publication
(10) Pub. No.: US 2024/0347950 A1
(43) Pub. Date: Oct. 17, 2024

(54) ELECTRICAL CONNECTOR, PLUG-IN ADAPTER, ARRANGEMENT FORMED WITH SAME, AND METHOD FOR MOUNTING A PLUG-IN ADAPTER

(71) Applicant: WAGO Verwaltungsgesellschaft mbH, Minden (DE)

(72) Inventors: Sebastian WEBER, Petershagen (DE); Rudolf MASTEL, Minden (DE); Justin RENGEL, Porta Westfalica (DE)

(73) Assignee: WAGO Verwaltungsgesellschaft mbH, Minden (DE)

(21) Appl. No.: 18/633,075

(22) Filed: Apr. 11, 2024

(30) Foreign Application Priority Data
Apr. 12, 2023 (DE) 10 2023 109 166.2

(51) Int. Cl. H01R 13/115; H01R 12/70; H01R 13/436; H01R 13/506

(52) U.S. Cl. CPC H01R 13/115; H01R 12/7023; H01R 13/436; H01R 13/506

(57) ABSTRACT

A connector for electrically connecting a first plug connection to a second plug connection. A plug-in adapter for the pluggable connection of a multipole electrical circuit board terminal is also provided, the plug-in adapter has a plurality of connectors of the above-mentioned type. An arrangement including such a plug-in adapter, a multipole electrical circuit board terminal, and an electrical circuit board, and a method for mounting a plug-in adapter of the above-mentioned type are also provided.

This nonprovisional application claims priority under 35 U.S.C. § 119 (a) to German Patent Application No. 10 2023 109 166.2, which was filed in Germany on Apr. 12, 2023, and which is herein incorporated by reference.

### BACKGROUND OF THE INVENTION

### Field of the Invention

The invention relates to a connector for electrically connecting a first plug connection to a second plug connection. The invention further relates to a plug-in adapter for the pluggable connection of a multipole electrical circuit board terminal, wherein the plug-in adapter has a plurality of connectors of the above-mentioned type. The invention further relates to an arrangement including such a plug-in adapter, a multipole electrical circuit board terminal, and an electrical circuit board, and to a method for mounting a plug-in adapter of the above-mentioned type.

### Description of the Background Art

In general, the invention relates to the field of electrical connection technology, utilizing electrical plug connections as are known from plug connectors, for example. In various situations, it may be necessary to adapt specified electrical components, for example circuit board terminals, in a certain manner in an application that differs from that originally intended by the manufacturer. For this purpose, specialized electrical connectors and/or plug-in adapters may be used with such connectors. For example, a connection adapter for attaching a circuit board terminal to a circuit board is known from DE 10 2012 105 508 B4, which corresponds to US 2015/0188248, which is incorporated herein by reference.

### SUMMARY OF THE INVENTION

It is therefore an object of the invention to provide a universally usable connector for electrically connecting a first plug connection to a second plug connection, and a plug-in adapter thus formed. Moreover, the intent is to provide an arrangement including such a plug-in adapter, a multipole electrical circuit board terminal, and an electrical circuit board, as well as a method for mounting such a plug-in adapter.

This object is achieved, in an example, by a connector for electrically connecting a first plug connection to a second plug connection, the connector having a connecting body made of electrically conductive material. The connecting body has an angled shape, for example an L-shaped configuration. The connecting body has a first leg and a second leg situated at an angle thereto, for example essentially at a right angle. A first plug contact for electrically contacting the first plug connection is situated in the region of the free end of the first leg, and a second plug contact for electrically contacting the second plug connection is situated in the region of the free end of the second leg. Due to its angled shape, such a connector may be used in a very universal manner. In particular, due to the first and second legs that are situated at an angle relative to one another, the connector may be inserted, for example, into a plug-in adapter in different spatial orientations, thus fulfilling different functions. In particular, by use of such a connector, a plug-in adapter may be designed with a plurality of identical parts, i.e., a plurality of such connectors that are predominantly or completely identical in structure. It is thus possible to reduce the number of components for the plug-in adapter.

The first leg may be longer than the second leg. Due to its L-shaped configuration, for example, such a connector may be used in a particularly universal manner, in particular in the mentioned plug-in adapter.

Thus, in the connector according to the invention, the directions of longitudinal extension of the first leg and of the second leg can be essentially orthogonal relative to one another. The connector may be made of a flat material, in particular a flat sheet metal material, for example by use of a stamping/bending process. The first leg has the greatest spatial dimension in its direction of longitudinal extension, in comparison to its width and thickness. The width of the first leg may be greater than, or also equal to, the thickness. The second leg has the greatest spatial dimension in its direction of longitudinal extension, in comparison to its width and thickness. The width of the second leg may be greater than, or also equal to, the thickness. The first plug contact may be formed in one piece with the first leg or fastened thereto in an integrally bonded, force-fit, and/or form-fit manner. The second plug contact may be formed in one piece with the second leg, or may be fastened thereto in an integrally bonded, force-fit, and/or form-fit manner.

The first plug contact and/or the second plug contact can be designed as a socket contact into which a pin contact or blade contact is insertable as a mating piece. For example, such a socket contact may be designed with two oppositely situated spring lamellae, between which the pin contact or blade contact is insertable. The socket contact may be designed as a tulip contact and/or as a fork contact, for example.

The first plug contact can have a first insertion direction in which the first plug connection is contactable with the first plug contact, and the second plug contact has a second insertion direction in which the second plug connection is contactable with the second plug contact. The first insertion direction may be situated in parallel to the second insertion direction or may be aligned with the second insertion direction. In abstract terms, the particular insertion direction is understood to be analogous to a vector in the mathematical sense.

The first insertion direction can extend in a different direction than the second insertion direction. This allows particularly universal usability of the electrical connector.

The first insertion direction can extend obliquely with respect to the second insertion direction. This allows particularly universal usability of the electrical connector.

The first insertion direction can extend in parallel to the direction of longitudinal extension of the first leg, and/or the second insertion direction extends in parallel to the direction of longitudinal extension of the second leg. Accordingly, the first insertion direction may extend slightly offset with respect to the first leg, and/or the second insertion direction may extend slightly offset with respect to the second leg. The first and second insertion directions are oriented essentially perpendicularly with respect to one another.

The first leg and the second leg span a plane, with respect to which the first insertion direction and/or the second insertion direction can extend in parallel. The plane may extend centrally through the first and second legs-in a manner of speaking, in a neutral fiber in the direction of longitudinal extension of the particular leg.

The first leg and/or the second leg may be situated, in the direction of longitudinal extension and in the width direction, in parallel to this plane spanned by the first leg and the second leg; i.e., the thickness direction extends orthogonallly with respect to this plane.

The first plug contact and the second plug contact can be situated on opposite sides of the plane. In other words, the first plug contact is situated on a first side of a plane that is formed by the first leg and the second leg, and the second plug contact is situated on a second side of the plane, the first and second sides being opposite one another relative to the plane.

A plane spanned by the first insertion direction and the second insertion direction can extend in parallel to the plane spanned by the first leg and the second leg, and the other of the first direction and second insertion direction extends orthogonally with respect to the plane. The connector may thus have an even more compact design, in particular without the transverse web that is explained below, or at least with a reduced size of the transverse web.

The first insertion direction can be offset with respect to the second insertion direction in a direction that is orthogonal with respect to the plane spanned by the first leg and the second leg. The universal usability of the connector is further improved in this way.

The first plug contact can have a continuous first opening in the first insertion direction, and/or the second plug contact can have a continuous second opening in the second insertion direction. This allows the first plug connection or the second plug connection to be insertable into the respective first or second plug contact in opposite directions. The first or second plug contact thus has essentially no conductor stop, so that the plug connection may be inserted from both sides. The first or second plug contact is then contactable in the sense of a tap, i.e., continuously.

The connector can have a transverse web whose direction of longitudinal extension extends essentially orthogonally in a plane spanned by the first leg and the second leg, the second plug contact being connected to the second leg via the transverse web. In this way, the connector may also bridge some space in the transverse direction with respect to the stated plane. The transverse web may in particular be designed as a third, relatively short leg on the connecting body. In particular, the transverse web may be shorter than the second leg.

### Example A

A connector for electrically connecting a first plug connection to a second plug connection, the connector having a connecting body made of electrically conductive material and having an angled shape, in particular an L shape, with a first leg and a second leg situated at an angle thereto, a first plug contact for electrically contacting the first plug connection being situated in the region of the free end of the first leg, and a second plug contact for electrically contacting the second plug connection being situated in the region of the free end of the second leg, the first plug contact having a first insertion direction in which the first plug connection is contactable with the first plug contact, and the second plug contact having a second insertion direction in which the second plug connection is contactable with the second plug contact, and the first insertion direction being oblique to the second insertion direction.

### Example B

A connector for electrically connecting a first plug connection to a second plug connection, the connector having a connecting body made of electrically conductive material and having an angled shape, in particular an L shape, with a first leg and a second leg situated at an angle thereto, a first plug contact for electrically contacting the first plug connection being situated in the region of the free end of the first leg, and a second plug contact for electrically contacting the second plug connection being situated in the region of the free end of the second leg, wherein the first plug contact is situated on a first side of a plane that is formed by the first leg and the second leg, and the second plug contact is situated on a second side of the plane, the first and second sides being opposite one another relative to the plane.

### Example C

A connector for electrically connecting a first plug connection to a second plug connection, the connector having a connecting body made of electrically conductive material and having an angled shape, in particular an L shape, with a first leg and a second leg situated at an angle thereto, a first plug contact for electrically contacting the first plug connection being situated in the region of the free end of the first leg, and a second plug contact for electrically contacting the second plug connection being situated in the region of the free end of the second leg, the first plug contact having a first insertion direction in which the first plug connection is contactable with the first plug contact, and the second plug contact having a second insertion direction in which the second plug connection is contactable with the second plug contact, and the first plug contact having a continuous first opening in the first insertion direction, and/or the second plug contact having a continuous second opening in the second insertion direction.

Each of the Examples A, B, C may be advantageously combined with one or more of the examples of the invention explained above.

Furthermore, the object stated at the outset is achieved by a plug-in adapter for the pluggable connection of a multipole electrical circuit board terminal that includes a plurality of circuit board connector pins, the plug-in adapter including a housing having, on a plug connection side, insertion openings for connecting the circuit board connector pins of the circuit board terminal, wherein a plurality of connectors of the above-mentioned type are situated in the housing, wherein a plurality of elongated pin contacts, which extend from the housing on a side of the housing that is different from the plug connection side, are situated in the housing, in each case an elongated pin contact in the housing being plugged together with the first or the second plug contact of a connector. The above-mentioned advantages are also achieved in this way. The connectors situated in the housing may be advantageously fixed in the housing by the elongated pin contact which is respectively associated with the connectors, and which is plugged together with the respective connector. Additional mechanical fixing of the connector is then not necessary.

In particular, by use of the plug-in adapter, advantageous adaptation of a circuit board terminal to an electrical circuit board may take place in which the circuit board terminal with its circuit board connector pins is situated not in the plane of the electrical circuit board, but in a different plane. This is advantageous in particular for circuit board terminals with spring-loaded clamping connections, in which the spring-loaded clamping connections are actuated by respective actuating levers. For example, by use of the plug-in adapter, adaptation of the circuit board terminal may take place in such a way that the actuating levers are situated in parallel to the plane of the electrical circuit board. This allows good actuating capability of the actuating levers, i.e., an ergonomic attachment of the circuit board terminal. The circuit board terminal with its circuit board connector pins is not soldered to the circuit board as provided, but instead is merely plugged together, as a plug connector, with plug contacts of the plug-in adapter. This plug connection may also be disconnected. The circuit board connector pins of the circuit board terminal are oriented essentially perpendicularly with respect to the elongated pin contacts situated in the plug-in adapter.

A pin contact may always be plugged together with one plug contact of a connector in each case. The remaining plug contact of the connector is then used to plug the connector and a circuit board connector pin of the circuit board terminal together.

In an example, most or all of the connectors can have a structurally identical design, and/or that most or all of the elongated pin contacts can have a structurally identical design. In this way, components that are largely uniform may be used, which is advantageous for minimizing the number of components of the plug-in adapter.

The housing for each connector to be inserted at that location can have a receiving chamber which is adapted to the geometry and spatial orientation of the connector to be inserted, and which is designed as the negative contour of the connector to be inserted. In this way, the particular connector is already fixed in the housing in multiple spatial directions by means of the correspondingly adapted receiving chamber, even if the connection is initially inserted loosely therein. Final fixing, which protects the connector from falling out of the housing, then takes place by plugging the connector and the elongated pin contact together. In the process, the elongated pin contacts are advantageously accommodated, at least in sections, in a form-fit and/or force-fit manner in recesses that are adapted to the shape of the pin contacts.

The object is further achieved by an arrangement including a plug-in adapter of the above-mentioned type, a multipole electrical circuit board terminal with a plurality of circuit board connector pins, and an electrical circuit board, wherein the plug-in adapter with its elongated pin contacts protruding from the housing is connected to solder terminal sites of the circuit board, and the circuit board terminal with its circuit board connector pins is connected to plug contacts of the connectors situated in the housing. The above-mentioned advantages may also be achieved in this way. The elongated pin contacts of the plug-in adapter may be soldered to the solder terminal sites of the circuit board and/or fixed at that location via a force fit.

The plug-in adapter at its housing may have at least one fastening element, which may be designed as a flexible locking arm, for example, for fixing the circuit board connecting clamp.

The elongated pin contacts may in particular have a length that is at least as great as the length of the housing of the plug-in adapter in the insertion direction of the pin contacts in the housing. In particular, the pin contacts may have a slightly greater length, so that they extend completely through the housing, and at a housing side protrude slightly from the housing. The circuit board connector pins may advantageously protrude from the housing of the circuit board terminal at a first housing side.

The circuit board terminal may be designed as a spring-loaded clamp that has a spring-loaded clamping connection for a respective circuit board connector pin. The spring-loaded clamping connection has at least one clamping spring. For each clamping spring the circuit board terminal may have a manual actuating element, in particular a swivelable actuating lever, via which the clamping spring may be placed in an open position. By use of the clamping spring, an electrical conductor that is introduced into a housing of the circuit board terminal may be connected to a busbar situated in the housing, or may be directly connected to the circuit board connector pin by spring-loaded clamping.

Also, on a second housing side diametrically opposed to the first housing side, the housing may have conductor insertion openings for introducing the electrical conductors into the spring-loaded clamping connections. In a further advantageous example, the actuating levers may be situated on a third housing side of the circuit board terminal, which is situated essentially orthogonally with respect to the first and second housing sides, and/or which extends from the first housing side to the second housing side and thus connects these housing sides.

The object stated at the outset is further achieved by a method for mounting a plug-in adapter of the above-mentioned type, comprising the following steps:
a) inserting a connector of the above-mentioned type into a receiving chamber of the housing of the plug-in adapter provided for this purpose,
b) plugging the pin contact, to be plugged together with the connector, into the housing, thereby fixing the connector in the housing,
c) repeating steps a), b) until all connectors and pin contacts are inserted into the housing.

In this way, the plug-in adapter may be mounted in a particularly simple and cost-effective manner. In addition, automatic mounting, using a robot, for example, is possible. The receiving chamber is initially prefixed in multiple spatial directions by inserting the connector therein. The final fixing of the connector then takes place by plugging the connector and the pin contact together.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 and 2 show a connector in various perspective views;

FIG. 3 shows a connector in a perspective view;

FIG. 4 shows the connector according to FIG. 3 in a side view;

FIG. 5 shows various examples for contacting a connector to one of multiple pin contacts;

FIG. 6 shows a plug-in adapter in a side view;

FIG. 7 shows a sectional view of the plug-in adapter according to FIG. 6 in the section plane A-A;

FIG. 8 shows a plug-in adapter in a side view with a circuit board terminal arranged thereon;

FIG. 9 shows the arrangement according to FIG. 8 without the housing of the plug-in adapter;

FIG. 10 shows the arrangement according to FIG. 8 in a perspective view;

FIG. 11 shows the arrangement according to FIG. 9 in a perspective view; and

FIG. 12 shows a plug-in adapter together with a circuit board terminal, in an exploded view.

### DETAILED DESCRIPTION

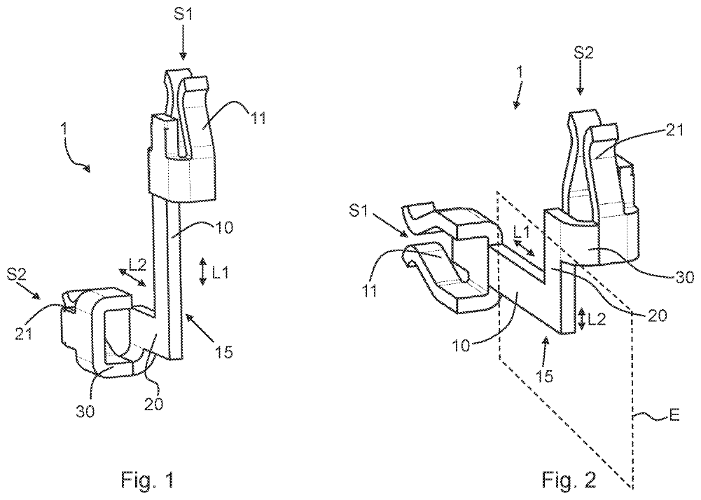

The connector 1 illustrated in FIGS. 1 and 2 has a connecting body 15 made of electrically conductive material. The connecting body 15 has an angled shape, for example in an L-shaped configuration, with a first leg 10 and a second leg 20, situated at an angle thereto, for example in the range of 45 to 135 degrees or in particular at a right angle. The first leg 10 may be longer than the second leg 20, in each case measured in the direction of longitudinal extension L1 of the first leg or in the direction of longitudinal extension L2 of the second leg 20.

A first plug contact 11, for example in the form of a socket contact, is situated in the region of the free end of the first leg 10. A second plug contact 21, which likewise may be designed in the form of a socket contact, is situated in the region of the free end of the second leg 20. The entire connector 1 is electrically conductive. The connector 1 may be used to electrically connect a first plug connection to a second plug connection, for example by plugging the first plug connection and the first plug contact 11 together, and plugging the second plug connection and the second plug contact 21 together.

It is also apparent that the first plug contact 11 has a first insertion direction S1 in which the first plug connection is contactable with the first plug contact 11. The second plug contact 21 has a second insertion direction S2 in which the second plug connection is contactable with the second plug contact 21. It is apparent that the insertion directions S1, S2 extend essentially at a right angle relative to one another. The insertion directions S1, S2 are not situated in the same plane E that is spanned by the first leg 10 and the second leg 20; instead, the insertion directions are each slightly offset orthogonally, in particular on various sides relative to the plane E.

Furthermore, it is apparent that the second plug contact 21 is not situated directly at the second leg 20, but instead is connected thereto via a transverse web 30. Due to the transverse web 30, which extends essentially orthogonally with respect to a plane that is spanned by the first leg 10 and the second leg 20, the second plug contact 21, and thus the second insertion direction S2, may be situated slightly even more offset with respect to the plane that is spanned by the first leg 10 and the second leg 20.

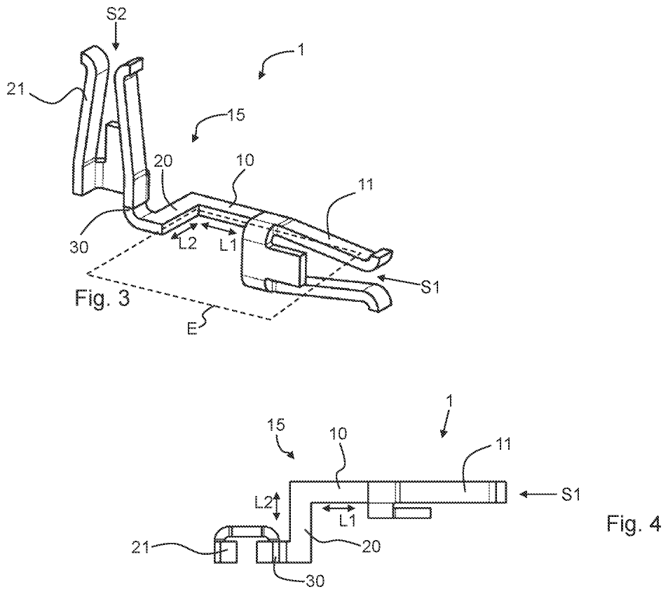

FIGS. 3 and 4 show a further example of a connector 1, which once again has a connecting body 15 that is made of electrically conductive material and that includes the mentioned first leg 10 and second leg 20. Once again, a first plug contact 11 is situated at the first leg 10, and a second plug contact 21 is situated at the second leg 20, once again via a transverse web 30 which in this case is relatively short. Whereas in the examples in FIGS. 1 and 2, both insertion directions S1, S2 extend in parallel to the plane spanned by the first and second legs 10, 20, in the example in FIGS. 3 and 4 only the first insertion direction S1 is parallel to this plane, and the second insertion direction S2 is oriented essentially orthogonally with respect to this plane. With such a design, the connector may have an even simpler design, and accordingly may be manufactured more cost-effectively.

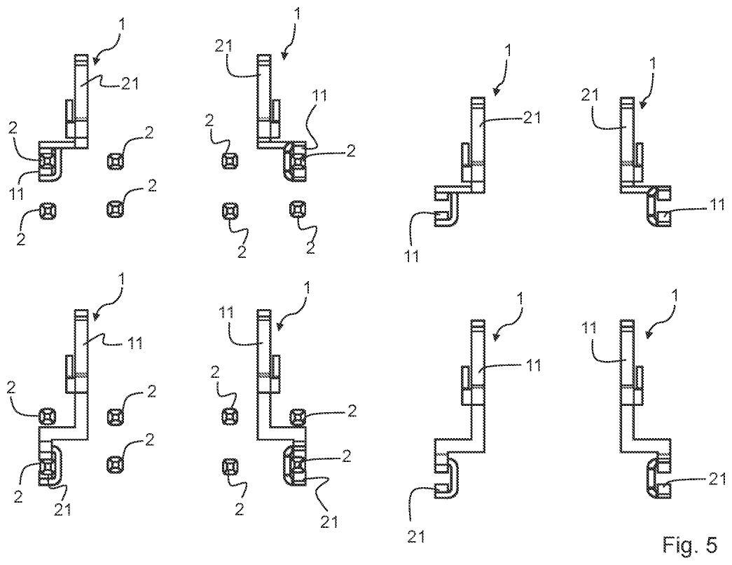

Due to the universal usability of such a connector 1, the first and the second plug connections, with which the first and second plug contacts 11, 21 may be respectively plugged together, may each be associated differently. Examples are described below in which a circuit board terminal, having the circuit board connector pins, is to be connected to elongated pin contacts 2 of a plug-in adapter via multiple connectors 1. The connectors 1 may be inserted in different spatial orientations, as illustrated in FIG. 5. Each desired connection between a circuit board connector pin of a circuit board terminal and a pin contact 2 may be advantageously achieved using connectors 1 having identical designs. Depending on the spatial position of the connector 1, in some cases an elongated pin contact 2 then forms a first plug connection or a second plug connection; i.e., the pin contact 2 in each case is either connected to the first plug contact 11 or to the second plug contact 21 of the connector 1. Analogously, a circuit board connector pin of a circuit board terminal may selectively be the first or the second plug connection; i.e., this connector pin is then connected to the particular plug contact 11, 21 of the connector 1 that is still free.

The following examples assume, as also shown in FIG. 5, that the plug-in adapter has an arrangement of eight parallel elongated pin contacts 2 situated in parallel, which are provided in a 2×4 configuration, i.e., in two planes one above the other, wherein four pin contacts 2 are adjacently situated in each case. It is apparent in FIG. 5 that the connectors 1 are connected to the pin contacts 2 of the upper plane in a first spatial orientation; i.e., the connectors 1 with the first plug contact 11 are connected to the pin contact 2. In contrast, the connectors 1 are connected to the pin contacts 2 of the lower plane with the second plug contacts 21. As a result, the plug contacts 21, 11 of all connectors 1 above the two planes of the pin contacts 2 are situated on the same plane.

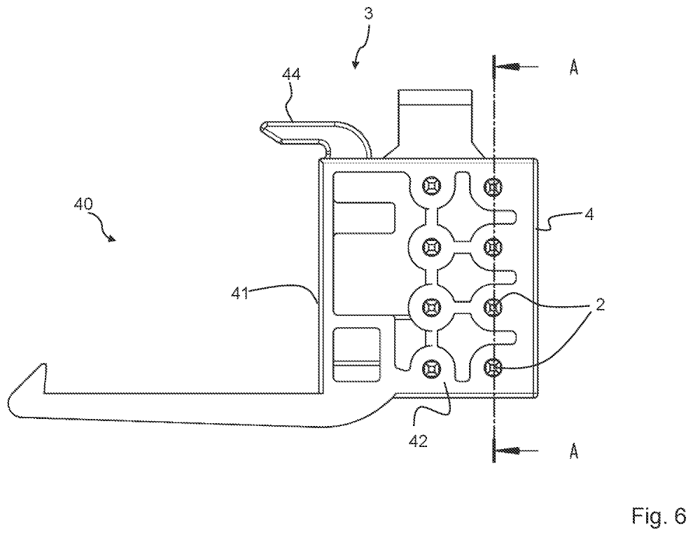

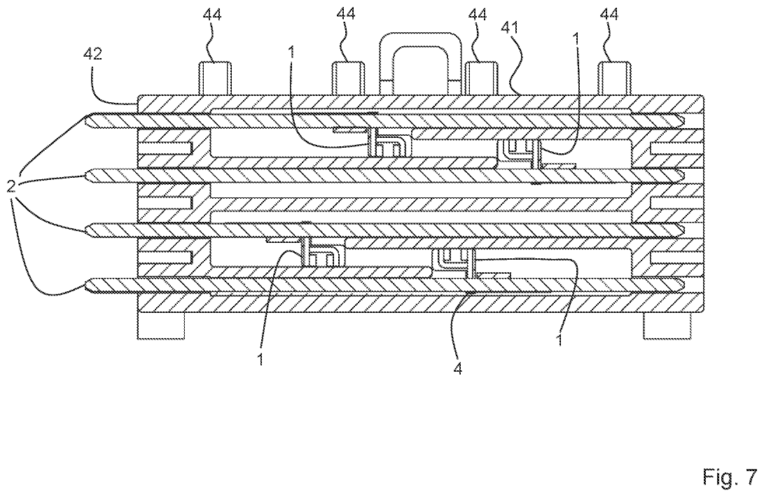

FIG. 6 shows a plug-in adapter 3 for the pluggable connection of a multipole electrical circuit board terminal. The plug-in adapter 3 has a housing 4 that includes a receiving space 40 for accommodating the circuit board terminal. The plug-in adapter 3 at its housing 4 has at least one fastening element, which may be designed as a flexible locking arm 44, for example, for fixing the circuit board terminal 5. On a plug connection side 41 the housing 4 has insertion openings for connecting circuit board connector pins of the circuit board terminal. The pin contacts 2 protrude from the housing 4 on a housing side that is different from the plug connection side 41, namely, a circuit board connection side 42. The internal design of the plug-in adapter 3 is explained with reference to the sectional illustration shown in FIG. 7, which depicts a cross section in the plane A-A.

It is apparent in FIG. 7 that the elongated pin contacts 2 extend essentially completely through the housing 4; i.e., in the region at the right they almost reach the end of the housing 4, and at the left side, i.e., the circuit board connection side 42, they protrude from the housing 4. In the housing 4, in each case a pin contact 2 is connected to a first or second plug contact 11, 21 of a connector 1, as already explained with reference to FIG. 5.

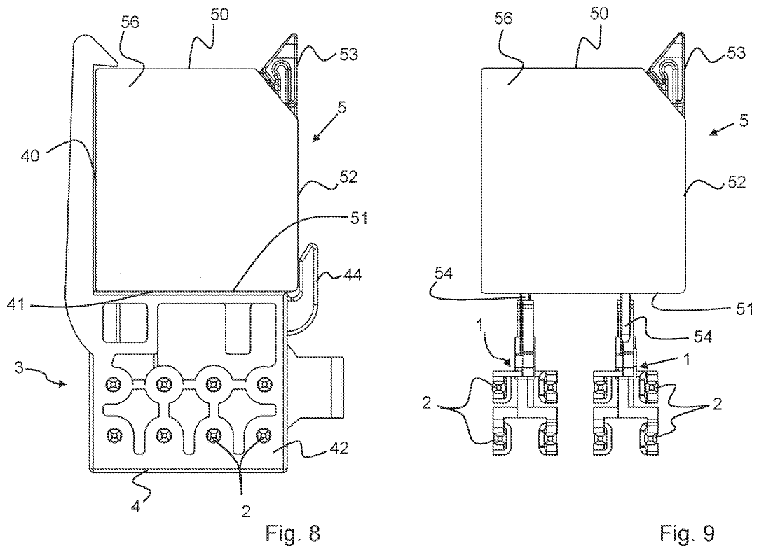

FIG. 8 shows an arrangement with the plug-in adapter 3 and a multipole electrical circuit board terminal 5 mounted thereon. FIG. 9 shows the arrangement in FIG. 8, but without the housing 4, so that it is easier to discern the electrical contacting via the connectors 1. As shown, the circuit board terminal 5 has a housing 56. Present in the housing 56 is a contact insert, from which circuit board connector pins 54 of the circuit board terminal 5 protrude at a first housing side 51. The circuit board connector pins 54 are in each case plugged together with a first or second plug contact 11, 21 of a connector 1. The plug contact 11, 21 of the particular connector 1 that is still free in each case is plugged together with a pin contact 2 of the plug-in adapter 3.

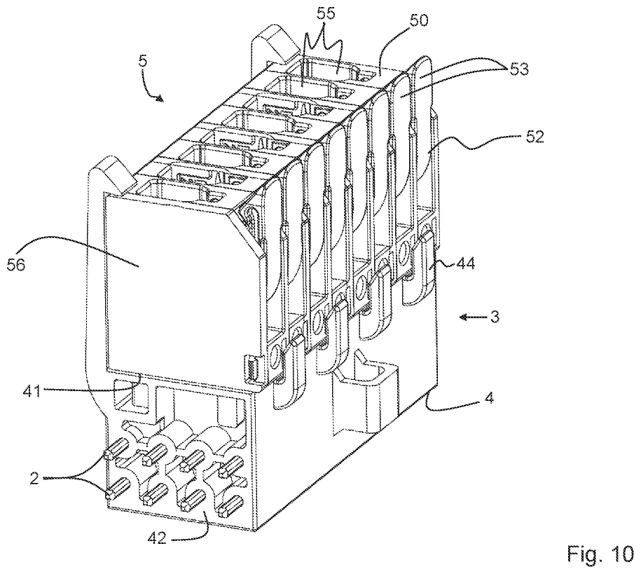

On the second housing side 50, diametrically opposed to the first housing side 51, the circuit board terminal 5 has conductor insertion openings 55, as is apparent in FIG. 10. Electrical conductors for spring-loaded clamping contact of the respective circuit board terminal 5 may be guided through the conductor insertion openings 55, and at that location may be clamped by means of elastic force. For manually actuating the particular spring-loaded clamping connection, the circuit board terminal 5 has multiple swivelable actuating levers 53 situated on a third housing side 52. The third housing side 52 forms a connection between the first housing side 51 and the second housing side 50.

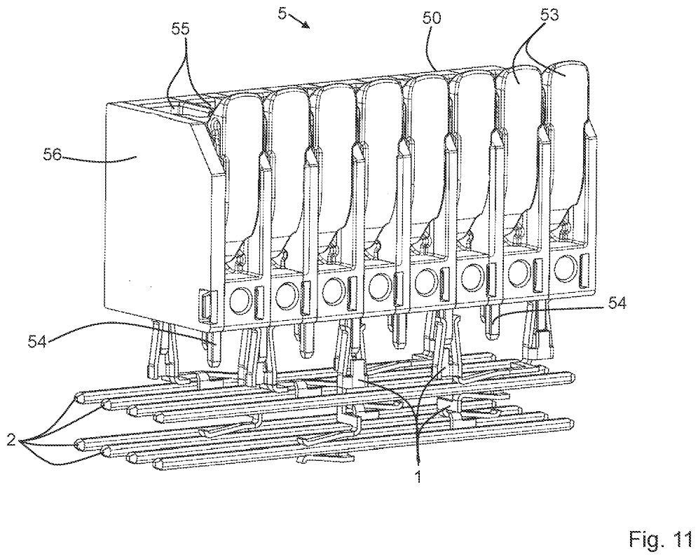

FIG. 11 once again explains, analogously to FIG. 9, the establishment of the electrical connection between the circuit board connector pins 54 and the pin contacts 2 via the structurally identical connectors 1 that are inserted in different spatial positions.

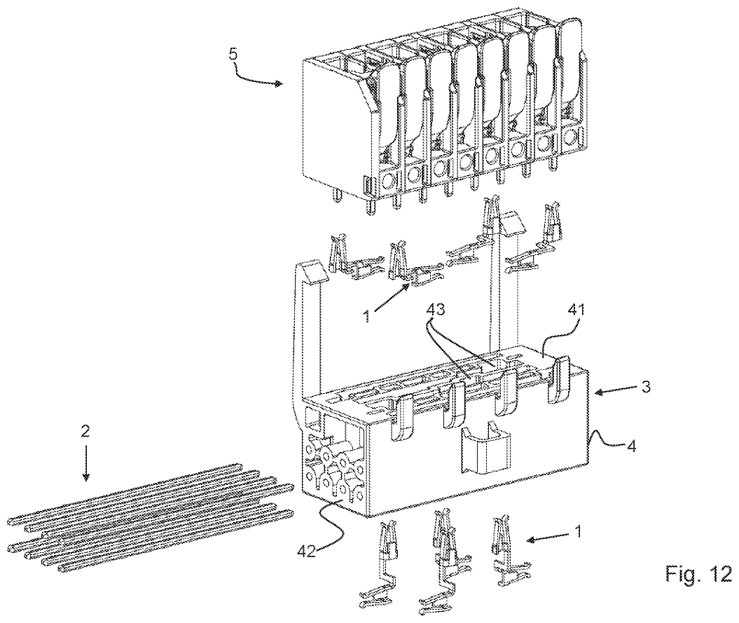

The assembly of the plug-in adapter 3 may be explained with reference to FIG. 12. The housing 4, for each connector 1 to be inserted at that location, has a receiving chamber 43 which is adapted to the geometry and spatial orientation of the connector 1 to be inserted, and which is designed as the negative contour of the connector 1 to be inserted. For example, the receiving chambers 43 for the connectors 1 of the upper plane of the pin contacts 2 may be accessible from the plug connection side 41, so that the connectors 1 may be inserted into the receiving chambers 43 from this housing side. The connectors 1 initially lie loosely in the respective receiving chambers 43. By inserting the upper plane of the pin contacts 2 into the housing 4, the contact with one of the plug contacts 11, 21 of a connector 1 is established in each case, as a result of which these connectors 1 are fixed in the housing 4. The housing 4 may now be rotated by 180 degrees, and the remaining connectors 1 from the housing side facing away from the plug connection side 41 may be inserted into the receiving chambers 43 that are accessible from this housing side. The remaining pin contacts 2, i.e., the pin contacts of the lower plane, are then inserted into the housing 4. The further connectors 1 are thus also fixed in the housing 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A connector for electrically connecting a first plug connection to a second plug connection, the connector comprising:
a connecting body made of electrically conductive material and having an angled shape or an L-shaped configuration, with a first leg and a second leg arranged at an angle thereto; and
a first plug contact to electrically contact the first plug connection arranged in the region of the free end of the first leg, and a second plug contact to electrically contact the second plug connection arranged in the region of the free end of the second leg.

2. The connector according to claim 1, wherein the first plug contact and/or the second plug contact are designed as a socket contact into which a pin contact or blade contact is insertable as a mating piece.

3. The connector according to claim 1, wherein the first plug contact has a first insertion direction in which the first plug connection is contactable with the first plug contact, and wherein the second plug contact has a second insertion direction in which the second plug connection is contactable with the second plug contact.

4. The connector according to claim 3, wherein the first insertion direction extends in a different direction than the second insertion direction.

5. The connector according to claim 3, wherein the first insertion direction extends obliquely with respect to the second insertion direction.

6. The connector according to claim 3, wherein the first insertion direction extends substantially in parallel to the direction of longitudinal extension of the first leg, and/or the second insertion direction extends substantially in parallel to the direction of longitudinal extension of the second leg.

7. The connector according to claim 3, wherein the first leg and the second leg span a plane with respect to which the first insertion direction and/or the second insertion direction extend substantially in parallel.

8. The connector according to claim 3, wherein the first plug contact and the second plug contact are arranged on opposite sides of the plane that is spanned by the first leg and the second leg.

9. The connector according to claim 3, wherein a plane spanned by the first insertion direction and the second insertion direction extends substantially in parallel to the plane spanned by the first leg and the second leg, and wherein the other of the first direction and second insertion direction extends orthogonally with respect to the plane.

10. The connector according to claim 8, wherein the first insertion direction is offset with respect to the second insertion direction in a direction that is orthogonal with respect to the plane.

11. The connector according to claim 3, wherein the first plug contact has a continuous first opening in the first insertion direction, and/or wherein the second plug contact has a continuous second opening in the second insertion direction.

12. The connector according to claim 1, wherein the connector has a transverse web whose direction of longitudinal extension extends essentially orthogonally in a plane spanned by the first leg and the second leg, and wherein the second plug contact is connected to the second leg via the transverse web.

13. The connector according to claim 1, wherein the first leg is longer than the second leg

14. A plug-in adapter for a pluggable connection of a multipole electrical circuit board terminal that comprises at least two circuit board connector pins, the plug-in adapter comprising:
a housing having, on a plug connection side, at least two insertion openings to connect the at least two circuit board connector pins of the circuit board terminal;
at least two connectors according to claim 1 arranged in the housing; and
at least two elongated pin contacts that extend from the housing at a side of the housing that is different from the plug connection side, wherein one of the at least two elongated pin contacts being plugged together with the first or the second plug contact of the connector.

15. The plug-in adapter according to claim 14, wherein most or all of the connectors have a structurally identical design, and/or wherein most or all of the elongated pin contacts have a structurally identical design.

16. The plug-in adapter according to claim 14, wherein the housing for each connector to be inserted at that location has a receiving chamber that is adapted to a geometry and spatial orientation of the connector to be inserted, and which is designed as the negative contour of the connector to be inserted.

17. An arrangement comprising:
a plug-in adapter according to claim 14;
a multipole electrical circuit board terminal with a plurality of circuit board connector pins; and
an electrical circuit board,
wherein the plug-in adapter with its elongated pin contacts protruding from the housing is connected to solder terminal sites of the circuit board, and
wherein the circuit board terminal with its circuit board connector pins is connected to plug contacts of the connectors arranged in the housing.

18. A method for mounting a plug-in adapter according to claim 14, the method comprising:
inserting a connector into a receiving chamber of the housing of the plug-in adapter that is provided for this purpose;
plugging the pin contact to be plugged together with the connector into the housing, thereby fixing the connector in the housing; and
repeating the step of inserting and plugging until all connectors and pin contacts are inserted into the housing.
